(19) United States
(12) Patent Application Publication
(10) Pub. No.: US 2025/0278681 A1
(43) Pub. Date: Sep. 4, 2025

(54) DELIVERY PLANNING APPARATUS, DELIVERY PLANNING METHOD, AND PROGRAM

(71) Applicant: NIPPON TELEGRAPH AND TELEPHONE CORPORATION, Tokyo (JP)

(72) Inventors: Zhao WANG, Tokyo (JP); Yusuke NAKANO, Tokyo (JP); Ken NISHIMATSU, Tokyo (JP); Kazuaki AKASHI, Tokyo (JP)

(73) Assignee: NIPPON TELEGRAPH AND TELEPHONE CORPORATION, Tokyo (JP)

(21) Appl. No.: 18/857,743

(22) PCT Filed: Apr. 21, 2022
(86) PCT No.: PCT/JP2022/018429

§ 371 Date: Oct. 17, 2024

(51) Int. Cl. G06Q 10/047; G06N 3/092; G06Q 10/083

(52) U.S. Cl. CPC G06Q 10/047; G06N 3/092; G06Q 10/083

(57) ABSTRACT

A delivery planning device includes an algorithm calculation unit that solves a vehicle routing problem for determining a route for providing a service to a plurality of nodes by a plurality of moving bodies using a neural network that performs reinforcement learning by an Actor-Critic method, in which the algorithm calculation unit has a plurality of actor networks corresponding to the plurality of moving bodies, and each actor network determines the route based on a state of a certain moving body and a state of the plurality of nodes.

### TECHNICAL FIELD

The present invention relates to a technique for solving a vehicle routing problem.

### BACKGROUND ART

The vehicle routing problem (VRP) is an optimization problem that, when a baggage is delivered to each customer from a baggage accumulation site (service center) by using a delivery vehicle, which delivery vehicle reaches which customer and in which order is optimal (whether the cost is lowest). In addition, the “vehicle routing problem” may be referred to as the “dispatch planning problem”.

In an actual application, there are many practical business scenarios in which distribution and service costs can be optimized through a solution of VRP, such as route generation of an e-commerce drone, just-in-time delivery of an e-commerce, cold-chain delivery, store replenishment, and the like.

Therefore, various variations of VRP are proposed according to different practical requirements. As a variation of the VRP, for example, there is a time-framed VRP (VRPTW). In the VRPTW, a time frame for product delivery is set for the customer. As another VRP, there is a multi-depot vehicle routing problem (MDVRP). In the MDVRP, there are a plurality of depots (service centers) from which a vehicle can depart or at which a vehicle can end traveling.

Since VRP and its variations have proven to be NP-hard problems, various operations research (OR) based methods that return approximate solutions have been studied for many years.

Usually, in an OR-based algorithm, a search model is manually defined, and a solution of VRP is obtained at the cost of solution quality in order to increase efficiency. However, the conventional OR-based method has two disadvantages.

A first disadvantage is that in a practical scale VRP problem (having 100 or more customers), in a case where the OR-based algorithm is used, calculation requires several days or several years to obtain an optimal solution or an approximate solution.

A second disadvantage is that different VRP variations require different OR algorithms because they require different hand-made search models and initial search conditions. For example, an inappropriate initial solution may lead to a long processing time and a local optimal solution. In this respect, the OR-based algorithm is difficult to generalize and use in real-world business scenarios.

Non Patent Literature 1 discloses a solution of VRP based on reinforcement learning of the Actor-Critic method, thereby solving the disadvantages of the OR-based algorithm. That is, the neural network model can greatly improve the complexity and the representation ability with high accuracy, particularly in a case where the number of customer nodes is large.

### CITATION LIST

### Non Patent Literature

Non Patent Literature 1: Nazari, Mohammadreza, Afshin Oroojlooy, Lawrence V. Snyder, and Martin Takac, “Reinforcement Learning for Solving the Vehicle Routing Problem”, NIPS, 2018.

### SUMMARY OF INVENTION

### Technical Problem

However, there is a problem that a difference (difference) between a plurality of delivery vehicles (or persons) cannot be considered in both OR and reinforcement learning. That is, when searching for the route of the VRP problem for the plurality of delivery vehicles, it is not possible to consider a difference between delivery vehicles such as a departure place and a loading amount of the delivery vehicle, whether a service can be provided to each customer (node), and the like by OR or reinforcement learning.

The present invention has been made in view of the above points, and an object thereof is to provide a technique capable of solving a vehicle routing problem in consideration of a difference between a plurality of delivery vehicles.

### Solution to Problem

According to the disclosed technology, there is provided a delivery planning device, including an algorithm calculation unit that solves a vehicle routing problem for determining a route for providing a service to a plurality of nodes by a plurality of moving bodies using a neural network that performs reinforcement learning by an Actor-Critic method, in which the algorithm calculation unit has a plurality of actor networks corresponding to the plurality of moving bodies, and each actor network determines the route based on a state of a certain moving body and a state of the plurality of nodes.

### Advantageous Effects of Invention

According to the disclosed technology, there is provided a technology capable of solving a vehicle routing problem in consideration of a difference between a plurality of delivery vehicles.

### BRIEF DESCRIPTION OF DRAWINGS

FIG. 1 is a device configuration diagram according to an embodiment of the present invention.

FIG. 2 is a configuration diagram of an algorithm calculation unit 130.

FIG. 3 is a diagram for explaining problem setting.

FIG. 4 is a diagram showing an algorithm (calculation procedure) of the algorithm calculation unit 130.

FIG. 5 is a diagram showing a hardware configuration example of a device.

### Description of Embodiments

An embodiment (the present embodiment) of the present invention will be described below with reference to the drawings. The embodiment described below is merely an example, and embodiments to which the present invention is applied are not limited to the following embodiment.

In addition, in the VRP problem of the present embodiment, the delivery vehicle moves and carries the baggage to the node (customer), and this is an example. The subject carrying the baggage may be a person or something other than the delivery vehicle and the person. The subject carrying the baggage may be collectively referred to as a “moving body”. In addition, in the present embodiment, the delivery of baggage is taken as an example of the “service”, and the “service” is not limited to the delivery of baggage.

### Outline of Embodiment

First, an outline of the present embodiment will be described. In the present embodiment, a data-driven, end-to-end policy based reinforcement learning framework is used to solve the VRP problem. The policy based reinforcement learning framework includes a neural network including an actor network and a critic network. A delivery route is generated by the actor network, and a value function is estimated and evaluated by the critic network.

In particular, the present embodiment is characterized in that a plurality of actor networks corresponding to a plurality of agents is used in an algorithm calculation unit to be described later. Each agent is equivalent to each delivery vehicle. Each agent is formulated as a Markov Decision Process (MDP) for each time step and takes an action alternately while considering the state of another agent and the distribution of nodes.

The above configuration is fused with, for example, PointerNet and the Actor-Critic Neural Network model disclosed in Non Patent Literature 1 to constitute an overall algorithm.

As described above, by expressing each agent in each actor network, it is possible to consider a difference in feature amount of each agent.

In addition, as described above, by configuring each agent to act alternately (in order) for each time step, the agents act in order, and a state change of the environment (node) and a state update of the agent can be simultaneously considered. Therefore, it is possible to learn the neural network such that a better action can be taken.

In addition, with the configuration of the algorithm calculation unit according to the present embodiment, the cooperative multi-agent can be learned by E2E as a whole, and a result close to the optimum can be obtained. In a large-scale instance, the model according to the present embodiment can generate a solution superior to other commonly used heuristic models, and at the same time, can generate a solution in real time.

### Device Configuration Example

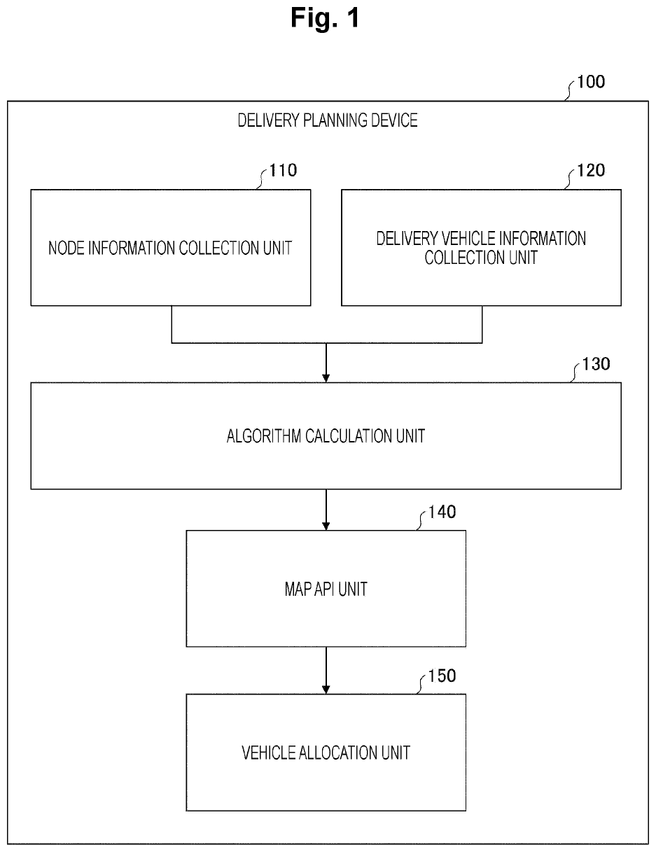

FIG. 1 shows a configuration diagram of a delivery planning device 100 according to the present embodiment. As shown in FIG. 1, the delivery planning device 100 includes a node information collection unit 110, a delivery vehicle information collection unit 120, an algorithm calculation unit 130, a map API unit 140, and a vehicle allocation unit 150.

The delivery planning device 100 may be implemented by one device (computer) or may be implemented by a plurality of devices. For example, the algorithm calculation unit 130 may be implemented in a certain computer, and other functional units may be implemented in another computer. An operation outline of the delivery planning device 100 is as follows.

The node information collection unit 110 acquires a feature amount of each node (customer). The feature amount of each node includes, for example, a node position, demand, and the like.

The delivery vehicle information collection unit 120 collects a feature amount of each delivery vehicle. The feature amount of each delivery vehicle includes, for example, a departure position and a loading amount of each delivery vehicle, whether a service can be provided to each node, and the like. The feature amount of each delivery vehicle collected by the delivery vehicle information collection unit 120 reflects a difference between delivery vehicles.

The algorithm calculation unit 130 outputs the delivery planning by solving the VRP problem based on the information of each node (customer) and each delivery vehicle. Details of the algorithm calculation unit 130 will be described later.

The map API unit 140 performs a route search based on the information of the delivery planning output from the algorithm calculation unit 130, and plots the route of the delivery planning of each delivery vehicle on the map, for example. Based on the output result of the map API unit 140, the vehicle allocation unit 150 distributes the service route information to each delivery vehicle (alternatively, the terminal of the service center) via the network. In addition, the vehicle allocation unit 150 may be referred to as an “output unit”.

The map API unit 140 may perform route search or the like by accessing, for example, an external map server. In addition, the map API unit 140 itself may store a map database and perform route search using the map database.

As an example, it is assumed that, as a delivery planning, a delivery planning of “0→2→3→0” is obtained by the algorithm calculation unit 130 for a certain delivery vehicle j. Here, 0 represents a node of a service center, and 2 and 3 each represent a number of a node corresponding to a customer. In this case, the map API unit 140 plots an actual road route of “service center→customer 2→customer 3→service center” on a map, and outputs the plotted map information on the route to the vehicle allocation unit 150.

### Configuration Example of Algorithm Calculation Unit 120

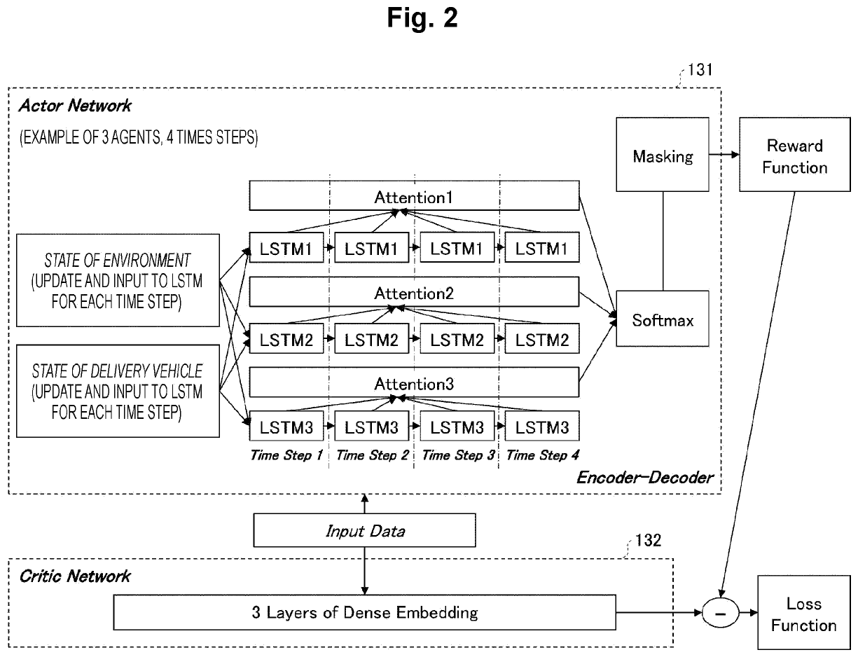

FIG. 2 shows a configuration example of the algorithm calculation unit 130. The algorithm calculation unit 130 is a model of a neural network that performs reinforcement learning of the Actor-Critic method.

As shown in FIG. 2, the model roughly includes two neural networks of an actor network 131 and a critic network 132.

The actor network 131 in the present embodiment has an actor network for a plurality of agents. That is, there are a plurality of actor networks corresponding to a plurality of agents. Each agent corresponds to each delivery vehicle. In the example of FIG. 2, an example of a case where an actor network for three agents is provided is shown. The actor network corresponding to the agent 1 includes an LSTM cell 1 and an attention layer 1, the actor network corresponding to the agent 2 includes an LSTM cell 2 and an attention layer 2, and the actor network corresponding to the agent 3 includes an LSTM cell 3 and an attention layer 3.

Note that, in the actor network 131, there is one dense embedding layer (equivalent to an encoder) in which input data (Input data) is input to each LSTM cell as an embedded representation, but in FIG. 2, the dense embedding layer is not shown for convenience of notation.

The actor network 131 includes a Softmax calculation unit (Softmax) and a masking unit (Masking) in addition to each LSTM cell and each attention layer. These form the encoder-decoder configuration and the pointer network configuration. The critic network 132 has a dense embedding layer (3 layers).

The actor network 131 has a learnable parameter for each agent. The critic network 132 (dense embedding layer) also has learnable parameters.

In the actor network 131, the state of the environment and the state of the delivery vehicle are input to each LSTM cell for each time step. In each agent, the feature amount obtained by the LSTM cell is input to the attention layer. An output from each attention layer is input to a Softmax calculation unit (Softmax), and a value calculated by Softmax is output through Masking and used for reward calculation. In the critic network 132, a loss (Loss Function) is obtained based on the feature amount obtained from the input data by the dense embedding layer and the reward, and learning is performed to reduce the loss.

The algorithm calculation unit 130 is configured to learn a large amount of simulation learning data using the neural network shown in FIG. 2 and perform a test (delivery planning creation) with both actual data and simulation data. In the algorithm calculation unit 130, the learning method itself in the reinforcement learning of the Actor-Critic method is similar to, for example, the learning method disclosed in Non Patent Literature 1.

Note that the actor network 131 in FIG. 2 includes a pointer network (PtrNet). The pointer network has an encoder and a decoder, the encoder reads an input sequence (node distribution), and the decoder determines which input to select by using an attention mechanism.

In addition, in the VRP, since the order of the input data is meaningless, the RNN encoder is omitted in the configuration shown in FIG. 2, and the embedded input is used.

In addition, the learning method is similar to the method disclosed in Non Patent Literature 1, and a policy gradient method is used. In the policy gradient method, each actor network predicts the probability distribution of the next action by PtrNet, and the critic network estimates the reward of the problem instance.

Hereinafter, the processing content of the algorithm calculation unit 130 will be described in more detail.

### Details of Processing of Algorithm Calculation Unit 130

### <Problem Setting>

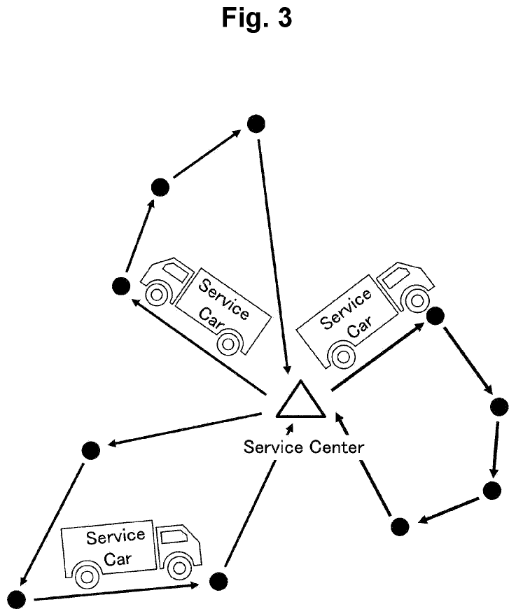

Problem setting in the present embodiment will be described with reference to FIG. 3. A set of nodes (which may also be referred to as customers) is located in a range on a map. Each black circle in FIG. 3 indicates a node that requires a service (delivery of a baggage in the present embodiment). In addition, there is a service center (baggage accumulation site) that loads baggage (which may also be referred to as a load) for service provision. It is assumed that the location of the node and the location of the service center are known. In addition, the travel time of the delivery vehicle may be known (for example, calculation is performed from a predetermined speed and distance) between the node and the service center or between any nodes, or may be calculated in consideration of an actual road situation (traffic congestion or the like) from the map API.

First, a set of delivery vehicles is placed in a service center. In the optimization problem of the present embodiment, when a baggage is delivered from the service center to each node by using a delivery vehicle, which delivery vehicle reaches which node and in which order it is optimal (whether the cost is the lowest) is considered. The above cost is, for example, a travel distance of the delivery vehicle. Note that the departure point may be different for each delivery vehicle. Furthermore, a node that can be visited, or a node that cannot be visited, may be determined for each delivery vehicle.

Each node receives service only once from any of the delivery vehicles. The delivery vehicle returns to the service center after visiting all planned nodes.

FIG. 3 shows an image in a case where there are three delivery vehicles (equivalent to three agents), and each of the delivery vehicles performs delivery on different delivery routes.

### <Input Data>

Input data to the LSTM indicated as “state of environment” and “state of delivery vehicle” in FIG. 2 will be described. Note that the “state of environment” is equivalent to the “state of node”.

When the state of the node i is described as xⁱ, xⁱ is expressed as follows. t represents each time in the time step.

xⁱ: {xₜⁱ={sⁱ, dₜⁱ), t=0, . . . , T}

The meanings of the symbols are as follows.
xⁱ: state of node i
sⁱ: two-dimensional coordinates (address) of the node i
dₜⁱ: demand at node i in step t (demand assumed to be different for each node)

The above demand is the same as the demand feature in the classical VRP problem.

When the state of the delivery vehicle j is described as yⁱ, y^{j} is expressed as follows.

y^{j}: {yₜ^{j}={pₜ^{j}, lₜ^{j}), t=0, . . . , T}

The meanings of the symbols are as follows.
y^{j}: state of delivery vehicle j
p^{j}: two-dimensional coordinates of the delivery vehicle j (current position updated for each step)
tₜⁱ: vehicle loading amount in step t (value that can be changed according to problem setting or ability of delivery person)

As the vehicle loading amount, a fixed initial load characteristic indicating the maximum loading capacity of the delivery vehicle may be defined for each delivery vehicle. Specifically, as an example, the load is initialized with a value of 1 (adjustable depending on the task) before the delivery vehicle leaves the service center and provides baggage to the node.

In addition, in the calculation, a condition may be provided in which in a case where the load of the delivery vehicle is close to 0 and the capacity to provide service to the remaining nodes (remaining load) is insufficient, the delivery vehicle returns to the service center.

Under the above input data and conditions, a solution ζ for the VRP problem is found. The solution ζ is a sequence of nodes that can be interpreted as a route of the service or an order of the service. For example, in a case where a sequence of ζ={0, 3, 2, 0, 4, 1, 0} is obtained as a solution, this sequence corresponds to two paths. One is a route going along 0→3→2→0, and the other is a route going along 0→4→1→0, which can be interpreted as a case where the corresponding delivery vehicle returns to the service center temporarily.

### <LSTM, Attention in Actor Network 131>

The solution ζ of the VRP problem is the Markov Decision Process (MDP) of the sequence, which is the process of selecting the next action (that is, which node is set as the delivery target next?) in the sequence.

In each agent, the action of the MDP is restored from the input data by using a long short-term memory (LSTM) cell and passed to the attention layer. The attention layer and Softmax output a pointer indicating a probability that each input node will receive a delivery. The actor network 131 may determine the next action (node to be visited next) as, for example, a node with the highest probability among all the nodes, or may determine the next action (node to be visited next) by another method based on the probability.

In the actor network 131, an action result and the input data described above are updated every time step. The input data in the time step t is as follows.
I node states: xₜ: {xₜⁱ={sₜⁱ, dₜⁱ), i=1, . . . , I}
J delivery vehicle statuses: yₜ: {yₜ^{j}={pₜ^{j}, lₜ^{j}), j=1, . . . , J}

At time step t, I node states are input to each LSTM cell. In the example of FIG. 2, the I node states are input to each of the LSTM cells 1 to 3. Regarding the delivery vehicle state, yₜ^{j} is input to the LSTM cell j of the actor network j corresponding to the delivery vehicle j. In the example of FIG. 2, yₜ¹ is input to the LSTM cell 1, yₜ² is input to the LSTM cell 2, and yₜ³ is input to the LSTM cell 3.

By the attention layer j and the softmax layer, aₜ^{j} is calculated for each agent based on the following formula.

uₜ^{j}=vₐ^{j}tanh(wₐ^{j}[xₜ; yₜ^{j}); ht])

aₜ^{j}=softmax (uₜ^{j})

Here, ht represents the hidden state of the LSTM cell in the time step t, and “;” represents the connection processing. aₜ^{j} represents the degree of relevance and represents the conditional probability of being selected next. vₐ^{j} and wₐ^{j} of each agent are parameters that can be learned.

Note that Softmax normalizes the vector uₜ^{j} (of length I) to an output distribution (probability distribution) for all nodes. That is, the probability of each node (the probability selected as the service target) in the time step t is output by aₜ^{j}=softmax (uₜ^{j}).

### <Masking>

Note that the masking technique disclosed in Non Patent Literature 1 can be used for the masking unit (masking in FIG. 2) of the present embodiment. For example, in a case where the remaining loading amount of the delivery vehicle is 0, the masking unit masks all the nodes (that is, no delivery is made anywhere). In addition, for example, the masking unit masks a node having a demand larger than the loading amount (load) of the current delivery vehicle (that is, the node is not delivered). Note that the loading amount of the delivery vehicle is reduced by the amount of the baggage every time the baggage delivery to the node is performed.

<Actor-Critic>

In the present embodiment, deep reinforcement learning based on Actor-Critic is used to simultaneously learn both a policy and a value function. Note that the deep reinforcement learning itself based on Actor-Critic is an existing technology.

For the actor network 131, an actor network corresponding to each agent j has a weight θj. A policy for each agent to select an action is represented by the actor network. The policy π_{θj} generates a probability distribution for the next action (which node to visit) in an arbitrary time step.

The policy π_{θj} for the delivery vehicle (agent) j is as follows.

$${π}_{θ j} ( a \vert {x}_{t} , {y}_{t} ) = {a}_{t}^{j}$$

The critic network 132 predicts how excellent the selected route is by using a three-layer DenseLayer (weight is ϕ) from the two-dimensional coordinates (address) of each node. An example of the value function for the prediction is as follows.

$${V}_{ϕ} ( s ) = Relu ( {W}_{3} \cdot Relu ( {W}_{2} \cdot Relu ( {W}_{1} \cdot s + {b}_{1} ) + {b}_{2} ) + {b}_{3} )$$

W₁, W₂, and W₃ are weights, respectively. b₁, b₂, and b₃ are predetermined constants. s is a two-dimensional coordinate of each node.

The policy gradient of the actor network 131 (agent j) is calculated based on the following formula. J (π_{θj}) is an evaluation function of the policy. ∇_{θj} J (π_{θj}) is a differential with respect to θj.

$${∇}_{θ j} J ( {π}_{θ j} ) = ( 1 / BT ) {Σ}_{b = 1}^{B} {Σ}_{t = 0}^{T} {∇}_{θ j} ( R - {V}_{ϕ} ( s ) ) \cdot log {π}_{θ j} ( {a}^{b} \vert {x}_{t}^{b} , {y}_{t}^{b} ; {θ}_{j} )$$

Note that B is the number of batches. R is a reward for the route taken by the delivery person j. For example, the reward is determined such that the shorter the length of the route, the higher the reward.

The gradient of the value of the critic network 132 is calculated based on the following formula. J (π_{θj}) is an evaluation function of the value. ∇_{ϕ}J (V_{ϕ} is a differential with respect to ϕ.

$${∇}_{ϕ} J ( {V}_{ϕ} ) = ( 1 / B ) {Σ}_{b = 1}^{B} {( R - {V}_{ϕ} ( s ) )}^{2}$$

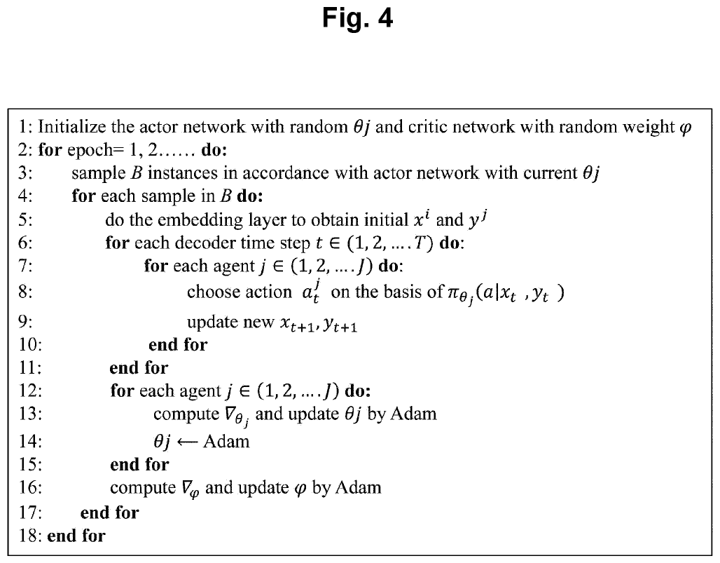

FIG. 4 shows an Actor-Critic algorithm (processing procedure of the algorithm calculation unit). Note that, since the weight update processing itself related to the reinforcement learning is similar to the existing technology described in Non Patent Literature 1 and the like, only an outline of the processing related to the reinforcement learning is shown.

In the first row, the actor network (each agent) is initialized with a random weight θj, and the critic network is initialized with a random weight ϕ. Note that a character immediately after random weight in the first line in FIG. 4 is described as ϕ in the description. The second line and the eighteenth line mean that the third line to the seventeenth line is to be repeated in each epoch.

In the third line, B instances are sampled in accordance with the actor network with the current θj. The fourth line and the seventeenth line mean that the fifth line to the sixteenth line are to be repeated for each sample in B.

In the fifth line, processing of the embedded layer of the actor network is performed to obtain initial input data (xⁱ, y^{j}). The sixth line and the eleventh line mean that the seventh line to the tenth line are repeated in each decoder step t∈(1, 2, . . . . T).

The seventh line and the tenth line mean that the eighth line to the ninth line are repeated for each agent j∈(1, 2, . . . . J).

In the eighth line, an action (action, that is, visit destination node) is selected based on the policy π_{θj}. In the ninth line, the current state (xₜ, yₜ) is updated to a new state (xₜ₊₁, yₜ₊₁) based on the result of the action. Specifically, for example, the delivery vehicle j is at the position of the node selected as the delivery destination, the loading amount is reduced by the baggage, and the demand of the node is reduced by the delivered baggage.

The twelfth line and the fifteenth line mean that the thirteenth line to the fourteenth line are repeated for each agent j∈(1, 2, . . . . J). In the thirteenth line and the fourteenth line, the policy gradient ∇_{θj} is calculated to update the weight θj of the actor network corresponding to agent j. In the sixteenth line, the gradient ∇_{ϕ} is calculated to update the weight ϕ of the critic network.

The Actor-Critic algorithm according to the present embodiment shown in FIG. 4 shows a training process. After this training process, a test (actual delivery planning output) may be performed, or the test may be performed while learning is performed.

In the algorithm of FIG. 4, as described above, the actor network having the weight θj of each agent j and the critic network having the weight ϕ are used.

In each learning repetition with the current weight θj of the actor network (agent j), a Monte Carlo simulation is used to generate a feasible sequence based on the current policy. This means that in each step of the decoder, the pointer is probabilistically calculated based on the distribution aₜ^{j}, which is the output of the actor network. Once the sampling ends, the reward and the gradient of policy are calculated, and θj is updated every j in the twelfth line to the fifteenth line. In the sixteenth line, the critic network is updated in the direction of decreasing the difference between the observed reward and the expected reward.

### Hardware Configuration Example

The delivery planning device 100 can be realized, for example, by causing a computer to execute a program. This computer may be a physical computer, or may be a virtual machine on a cloud.

That is, the delivery planning device 100 can be implemented by executing a program corresponding to processing performed by the delivery planning device using hardware resources such as a CPU and a memory built in the computer. The above program can be stored and distributed by being recorded in a computer-readable recording medium (portable memory or the like). In addition, the above program can also be provided through a network such as the Internet or e-mail.

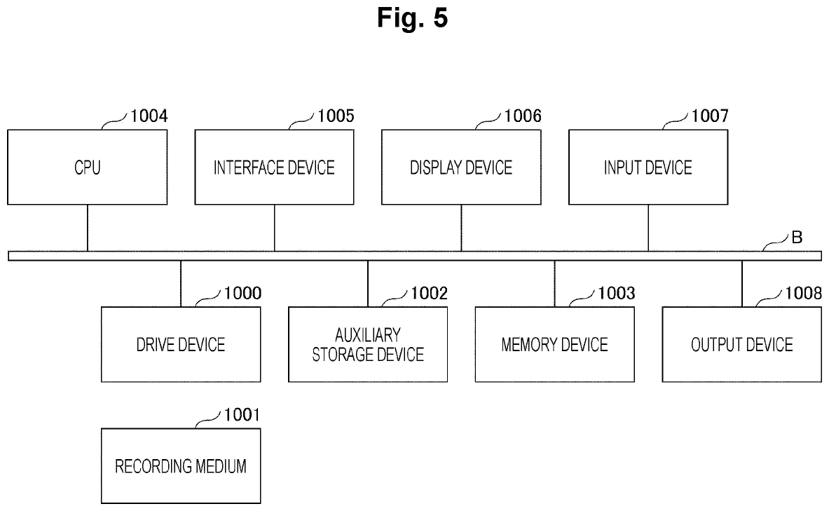

FIG. 5 is a diagram showing a hardware configuration example of the computer. The computer in FIG. 5 includes a drive device 1000, an auxiliary storage device 1002, a memory device 1003, a CPU 1004, an interface device 1005, a display device 1006, an input device 1007, an output device 1008, and the like, which are connected to each other by a bus BS.

The program for realizing the processing in the computer is provided by the recording medium 1001 such as a CD-ROM or a memory card. When the recording medium 1001 storing the program is set in the drive device 1000, the program is installed from the recording medium 1001 to the auxiliary storage device 1002 via the drive device 1000. Here, the program is not necessarily installed from the recording medium 1001 and may be downloaded from another computer via a network. The auxiliary storage device 1002 stores the installed program and also stores necessary files, data, and the like.

In a case where an instruction to start the program is made, the memory device 1003 reads the program from the auxiliary storage device 1002 and stores the program. The CPU 1004 realizes a function related to the delivery planning device 100 according to a program stored in the memory device 1003. Specifically, for example, as shown in FIG. 4, calculation of update of a state in the procedure, storage of updated data in the memory device 1003, reading of updated data from the memory device 1003 for the next time step, weight update calculation, and the like are executed.

The interface device 1005 is used as an interface for connection to a network or the like. The display device 1006 displays a graphical user interface (GUI) or the like according to the program. The input device 1007 includes a keyboard and a mouse, buttons, a touch panel, or the like, and is used to input various operation instructions. The output device 1008 outputs a computation result.

### Effects of Embodiments

As described above, with the technology according to the present embodiment, it is possible to solve the vehicle routing problem in consideration of a difference between a plurality of delivery vehicles.

### Supplementary Notes

The present description discloses at least the following delivery planning device, delivery planning method, and program.

### Supplement 1

A delivery planning device, including
an algorithm calculation unit that solves a vehicle routing problem for determining a route for providing a service to a plurality of nodes by a plurality of moving bodies using a neural network that performs reinforcement learning by an Actor-Critic method, in which
the algorithm calculation unit has a plurality of actor networks corresponding to the plurality of moving bodies, and each actor network determines the route based on a state of a certain moving body and a state of the plurality of nodes.

### Supplement 2

The delivery planning device according to supplement 1, in which
a state of each moving body includes at least a position and a loading amount, and a state of each node includes at least a position and a demand.

### Supplement 3

The delivery planning device according to supplement 1, in which
the algorithm calculation unit performs repeatedly the processing of determining an action and updating a state for each moving body in each time step.

### Supplement 4

A delivery planning method executed by a delivery planning device, the delivery planning method including
an algorithm calculation step of solving a vehicle routing problem for determining a route for providing a service to a plurality of nodes by a plurality of moving bodies using a neural network that performs reinforcement learning by an Actor-Critic method, in which
in the algorithm calculation step, each actor network in a plurality of actor networks corresponding to the plurality of moving bodies determines the route based on a state of a certain moving body and a state of the plurality of nodes.

### Supplement 5

A program for causing a computer to function as each unit in the delivery planning device according to any one of supplements 1 to 3.

While the present embodiment has been described above, the present invention is not limited to such a specific embodiment, and various modifications and changes can be made within the scope of the gist of the present invention described in the claims.

### REFERENCE SIGNS LIST

100 Delivery planning device
110 Node information collection unit
120 Delivery vehicle information collection unit
130 Algorithm calculation unit
140 Map API unit
150 Vehicle allocation unit
1000 Drive device
1001 Recording medium
1002 Auxiliary storage device
1003 Memory device
1004 CPU
1005 Interface device
1006 Display device
1007 Input device
1008 Output device

1. A delivery planning device comprising:
an algorithm calculation unit that solves a vehicle routing problem for determining a route for providing a service to a plurality of nodes by a plurality of moving bodies using a neural network that performs reinforcement learning by an Actor-Critic method, wherein
the algorithm calculation unit has a plurality of actor networks corresponding to the plurality of moving bodies, and each actor network determines the route based on a state of a certain moving body and a state of the plurality of nodes.

2. The delivery planning device according to claim 1, wherein
a state of each moving body includes at least a position and a loading amount, and a state of each node includes at least a position and a demand.

3. The delivery planning device according to claim 1, wherein
the algorithm calculation unit performs repeatedly the processing of determining an action and updating a state for each moving body in each time step.

4. A delivery planning method executed by a delivery planning device, the delivery planning method comprising:
solving a vehicle routing problem for determining a route for providing a service to a plurality of nodes by a plurality of moving bodies using a neural network that performs reinforcement learning by an Actor-Critic method, wherein
each actor network in a plurality of actor networks corresponding to the plurality of moving bodies determines the route based on a state of a certain moving body and a state of the plurality of nodes.

5. (canceled)

6. The delivery planning device according to claim 1, wherein
the algorithm calculation unit outputs a delivery plan by solving a vehicle routing problem (VRP) problem based on information on each node and each delivery vehicle.

7. The delivery planning method according to claim 4, wherein
a state of each moving body includes at least a position and a loading amount, and a state of each node includes at least a position and a demand.

8. The delivery planning method according to claim 4, wherein
the algorithm calculation unit performs repeatedly the processing of determining an action and updating a state for each moving body in each time step.

9. The delivery planning method according to claim 4, wherein
outputting a delivery plan by solving a vehicle routing problem (VRP) problem based on information on each node and each delivery vehicle.

10. A computer-readable non-transitory recording medium storing computer-executable program instructions that when executed by a processor cause a computer to execute a delivery planning method comprising:
solving a vehicle routing problem for determining a route for providing a service to a plurality of nodes by a plurality of moving bodies using a neural network that performs reinforcement learning by an Actor-Critic method, wherein
each actor network in a plurality of actor networks corresponding to the plurality of moving bodies determines the route based on a state of a certain moving body and a state of the plurality of nodes.

11. The computer-readable non-transitory recording medium according to claim 10 wherein the delivery planning method according to claim 10, further comprising:
a state of each moving body includes at least a position and a loading amount, and a state of each node includes at least a position and a demand.

12. The computer-readable non-transitory recording medium according to claim 10 wherein the delivery planning method according to claim 10, further comprising:
the algorithm calculation unit performs repeatedly the processing of determining an action and updating a state for each moving body in each time step.

13. The computer-readable non-transitory recording medium according to claim 10 wherein the delivery planning method according to claim 10, further comprising:
outputting a delivery plan by solving a vehicle routing problem (VRP) problem based on information on each node and each delivery vehicle.
